(19) United States
(12) Patent Application Publication
(10) Pub. No.: US 2023/0311217 A1
(43) Pub. Date: Oct. 5, 2023

(54) Method for releasing a screw connection between a core drilling device and a drill bit, and core drilling device

(71) Applicant: Hilti Aktiengesellschaft, Schaan (LI)

(72) Inventors: Martin SCHAEFER, Schwarzach (AT); Gabor VIDA, Chur (CH)

(21) Appl. No.: 18/022,911

(22) PCT Filed: Aug. 12, 2021
(86) PCT No.: PCT/EP2021/072467

§ 371 Date: Feb. 23, 2023

(30) Foreign Application Priority Data
Aug. 26, 2020 (EP) 20192833.0

(51) Int. Cl. B23B 31/06; B23B 31/11; B23B 51/04; B23B 45/02

(52) U.S. Cl. CPC B23B 31/06; B23B 31/11; B23B 51/0473; B23B 45/02; B23B 2270/09; B23B 2226/31

(57) ABSTRACT

A method for releasing a screw connection between a core drilling device and a drill bit, wherein the screw connection is released by application of torque spikes to the drive shaft of the core drilling device, these torque spikes coming into effect when the drive shaft is driven counter to the actual drilling direction of the core drilling device. A core drilling device with which the proposed method can be carried out is also provided. To this end, the core drilling device includes a drive shaft to which torque spikes can be applied, wherein the drive shaft can be driven in a drilling direction and a second direction of rotation which is opposite to the drilling direction. A core drilling device, in which the reversal of a direction of rotation of a drive shaft of the core drilling device and application of torque spikes to the drive shaft are combined with one another such that, as a result of the combination of the reversal of the direction of rotation and torque spikes, a screw connection between the core drilling device and a drill bit can be released.

The present invention relates to a method for releasing a screw connection between a core drilling device and a drill bit.

### BACKGROUND

Core drilling devices with which substantially cylindrical drill cores can be cut out of substrates to be worked, such as masonry, sand-lime brick or concrete, are known from the prior art. Lines or pipes, for example, can then be laid in or inserted into the substantially cylindrical boreholes. The core drilling devices can be connected to drill bits, wherein the drill bits are driven into the substrate in order to cut out the drill core.

### SUMMARY OF THE INVENTION

In conventional drilling systems made up of a core drilling device and a drill bit, screw connections are used in order to fasten the drill bit to the core drilling device. As a result of the significant forces that are applied during drilling, it is possible for such a screw connection to be released only with great difficulty under certain circumstances. This can be the case in particular when corrosion additionally occurs and the drill bit has not been separated from the core drilling device for a relatively long time.

In the prior art, primarily three procedures are known for releasing such connections that are difficult to release between a core drilling device and a drill bit. For example, it is known from the prior art to use aids, such as wrenches with long levers, in order to generate the forces necessary for separating the core drilling device and drill bit. In this case, respective wrenches are applied to the core drilling device and to the drill bit, wherein the lever action can be improved by the additional use of pipes or bars. This procedure is associated with the obvious drawback that the corresponding aids each have to be carried along and can easily be lost. Furthermore, it is necessary, in order to allow this procedure, to provide on the core drilling device and on the drill bit flats to which the aids can be applied and on which they can act. However, the provision of such flats frequently has the disadvantageous result that the core drilling device and the drill bit become larger and longer. This necessarily increases the production costs for the devices in question, and the material consumption. Furthermore, the core drilling devices and drill bits provided with flats in this way are heavier and as a result more difficult to handle and to replace or to fit.

Another possible way of making it easier to release a screw connection between a core drilling device and a drill bit is to use what are known as “quick release rings”. These are copper and/or rubber disks that can be fitted between the core drilling device and drill bit. However, such quick release rings are associated with the drawback that stiffness of the drilling system made up of the core drilling device and drill bit is reduced by the use thereof. However, reduced system stiffness can lead to difficulties at the start of drilling, i.e. when starting a drilling operation.

A third possible way of making it easier to release a screw connection between a core drilling device and a drill bit is to use a generous amount of lubricant. However, on account of the obvious drawbacks such as material consumption and contamination, this method is not suitable for providing a long-term satisfactory technical solution for separating the drill bit from the core drilling device.

An object of the present invention is to overcome the above-described deficiencies and drawbacks of the prior art and provide a method and a core drilling device that allow particularly easy releasing of the core drilling device and drill bit. The solution should in particular be easy to handle and not result in any additional contamination of the construction site. Above all, the invention should allow the drill bit to be released from the core drilling device without additional aids such as wrenches and/or pipes.

The present invention provides a method for releasing a screw connection between a core drilling device and a drill bit is provided, wherein the method comprises the following method steps:
a) providing a core drilling device having
   a drill bit which, during operation of the core drilling device, is fastened to the core drilling device by means of a screw connection, and having
   a drive shaft to which torque spikes are able to be applied, wherein, during operation of the core drilling device, the drill bit is driven in a drilling direction by means of the drive shaft of the core drilling device,
b) operating the core drilling device in a second direction of rotation, wherein the second direction of rotation is opposite to the drilling direction,
c) releasing the screw connection between a core drilling device and a drill bit through the rotation of the drive shaft in the second direction of rotation.

The basic idea of the invention is based on the interplay between the torque spikes and the changed direction of rotation of the drive shaft when the drill bit is intended to be released from the core drilling device. As a result of the torque spikes being applied to the drive shaft of the core drilling device and the change in the direction of rotation of the drive shaft, which is opposite to the actual drilling direction of the core drilling device, a possible way of separating the drill bit from the core drilling device without aids or tools can be provided. In other words, it is a substantial advantage of the proposed method that the screw connection between the core drilling device and the drill bit is released without tools. Furthermore, in the proposed separating method, it is possible to dispense with excess use of lubricant, and so the proposed method contributes to cost- and material-saving work on the construction site. Furthermore, unnecessary contamination by the lubricant is avoided, with the result that extensive cleaning work on the construction site can be prevented.

According to the invention, it is preferred that torque spikes are brief torque impulses that are much higher than the otherwise usual torque of the core drilling device. In this regard, the terms “torque spikes” and “torque impulses” can be used synonymously in the context of the present invention. According to the invention, it is preferred that the torque spikes are applied by the core drilling device, wherein the core drilling device can preferably comprise a motor, an electronic system and/or a control unit which are configured to bring about and to control both the reversal of the direction of rotation and the torque impulses. Therefore, in the context of the present invention, a method for controlling a core drilling device is also disclosed, with which reversal of a direction of rotation of a drive shaft and application of torque spikes to a drive shaft of a core drilling device can be controlled, wherein a screw connection between the core drilling device and a drill bit can be released using the control method. The control method can be realized for example as a computer program product that can be run on the core drilling device. In the context of the control method, a core drilling device can initially be operated in a first direction of rotation. This direction of rotation preferably represents the drilling direction of the drive shaft or of the drill bit. In other words, a drilling operation with which a drill core is cut out of a substrate can be carried out with the core drilling device, wherein the drive shaft and the drill bit rotate in the drilling direction during the drilling operation. If the drill bit is intended to be separated from the core drilling device, the core drilling device, the electronic system of the core drilling device and/or its control unit causes the direction of rotation of the drive shaft or of the drill bit to be changed from a first direction of rotation to a second direction of rotation. According to the invention, this change in the direction of rotation is referred to as the “reversal of the direction of rotation”. It is combined, according to the invention, with torque spikes, i.e. in addition to the reversal of the direction of rotation, torque spikes are applied to the drive shaft of the core drilling device. This preferably means, according to the invention, that the drive shaft is subjected to torque impulses while the drive shaft is rotating in a second direction of rotation. As a result of this combination of torque spikes and rotation of the drive shaft in a second direction of rotation which is opposite to the drilling direction of the core drilling device, the target, according to the invention, of separating the drill bit and core drilling device is advantageously achieved.

In the proposed control method, reversal of a direction of rotation of a drive shaft of the core drilling device and application of torque spikes to the drive shaft are combined with one another such that, as a result of the combination of the reversal of the direction of rotation and torque spikes, a screw connection between the core drilling device and a drill bit can be released. According to the invention, it is preferred that the drive shaft of the core drilling device is subjected to torque spikes during operation of the core drilling device in a second direction of rotation, such that, as a result of the combination of the reversal of the direction of rotation and the drive shaft being subjected to torque spikes, a drill bit can be separated from the core drilling device.

In the context of the present invention, it is provided that a core drilling device having a drive shaft and a drill bit is provided. The drive shaft is preferably configured to drive the drill bit. According to the invention, this can take place in a first direction of rotation, which is referred to as the “drilling direction” according to the invention. In the FIGURES, the drilling direction is provided with the reference sign “A”. The drilling direction is that direction of rotation of the drive shaft in which a drill core is cut out of a substrate. It can preferably also be referred to as the working or operating direction of the core drilling device. According to the invention, it is preferred that operating the core drilling device in the drilling direction can be used to provide support when fitting the drill bit. For example, rotating the drive shaft of the core drilling device “in the drilling direction” can be used to tighten the positioned drill bit and thus to reinforce the screw connection between the core drilling device and the drill bit.

An essential feature of the present invention is that the core drilling device that is proposed in the context of the present invention is capable of driving the drill bit, in addition to in the drilling direction, in a second direction of rotation, wherein this second direction of rotation is opposite to the first direction of rotation. In the FIGURES, the second direction of rotation is provided with the reference sign “B”. In other words, according to the invention, it is preferred that the core drilling device or its drive shaft is configured to drive the drill bit in a drilling direction and in a direction of rotation opposite to the drilling direction. This second direction of rotation is used, in the context of the invention, to release the drill bit from the core drilling device. According to the invention, the reversal of the direction of rotation is referred to as operation of the core drilling device “counter to the drilling direction” or “in the second direction of rotation”, wherein this means operation of the core drilling device in which the drive shaft of the core drilling device is driven counter to the drilling direction. Preferably, the expressions “counter to the drilling direction” and “in the second direction of rotation” are used synonymously according to the invention.

It is therefore preferred according to the invention that a direction of rotation of the drive shaft or of the drill bit of the core drilling device is changed when the drill bit is intended to be separated from the core drilling device. A change in the direction of rotation preferably means, according to the invention, that a direction of rotation of the core drilling device takes place from a first direction of rotation into a second direction of rotation, i.e. the drive shaft or the drill bit no longer rotates in a drilling direction but in a direction of rotation opposite to the drilling direction. As a result of this reversal of the direction of rotation, releasing or unscrewing of the drill bit from the core drilling device can be brought about or made easier.

In the context of the present invention, it is also provided that torque spikes are applied to the drive shaft of the core drilling device, said torque spikes helping to release the screw connection between the drill bit and core drilling device. According to the invention, it is particularly preferred that the inertia of the drill bit contributes to separating the drill bit from the core drilling device. Furthermore, fixing of the drill bit can help when releasing the drill bit from the core drilling device. Here, the drill bit is fixed such that it does not corotate when the drive shaft rotates.

As a result of the drive shaft rotating counter to the drilling direction in conjunction with the torque spikes with which the drive shaft of the core drilling device is subjected, it is possible for releasing of the screw connection between the core drilling device and drill bit to be allowed in particular without tools and aids. In other words, the invention provides a technical possibility for separating a screw connection between the core drilling device and the drill bit, which manages without additional aids or tools and is based on reversing the direction of rotation of the drive shaft and on subjecting the drive shaft of the core drilling device to torque spikes.

In a further aspect, the invention relates to a core drilling device, wherein the core drilling device is configured to carry out the method according to one of the preceding claims. The terms, definitions and technical advantages introduced for the separating method apply preferably in an analogous manner to the core drilling device. With the proposed core drilling device, a technical solution can be provided which advantageously allows the screw connection between the core drilling device and drill bit to be released without tools.

As a result, the core drilling device is advantageously rendered capable of carrying out the proposed separating method in that it comprises a drill bit and a drive shaft, wherein torque spikes can be applied to the drive shaft, said torque spikes being configured to release a screw connection between the core drilling device and a drill bit when the drive shaft of the core drilling device is driven counter to the drilling direction of the core drilling device.

According to the invention, it is preferred that the drive shaft of the core drilling device is configured to be driven in a drilling direction and in a direction of rotation opposite to the drilling direction. Preferably, the core drilling device comprises a motor for driving the drive shaft, wherein the core drilling device and its motor are preferably configured such that it is possible to drive the drive shaft in two opposite directions of rotation. According to the invention, it is very particularly preferred that the motor of the core drilling device is configured to generate torque spikes, the strength of which is sufficient to release the screw connection between the core drilling device and the drill bit.

According to the invention, it is preferred that the motor of the core drilling device is a brushless motor, since when brushless motors are used, it is much easier to carry out a reversal of the direction of rotation.

According to the invention, it is preferred that the core drilling device is a diamond core drilling device and that the drill bit is a diamond drill bit. Diamond drill bits can be studded with diamonds in order to improve their cutting performance compared with conventional drill bits. Diamond core drilling devices are preferably those core drilling devices that are used in order to drive diamond drill bits in rotation, in order to allow the drill cores to be cut out of the substrate.

### BRIEF DESCRIPTION OF THE DRAWINGS

Further advantages will become apparent from the following description of the figures. The FIGURE, the description and the claims contain numerous features in combination. A person skilled in the art will expediently also consider the features individually and combine them to form useful further combinations.

In the FIGURES:

FIG. 1 shows a view of a preferred configuration of the invention.

### DETAILED DESCRIPTION

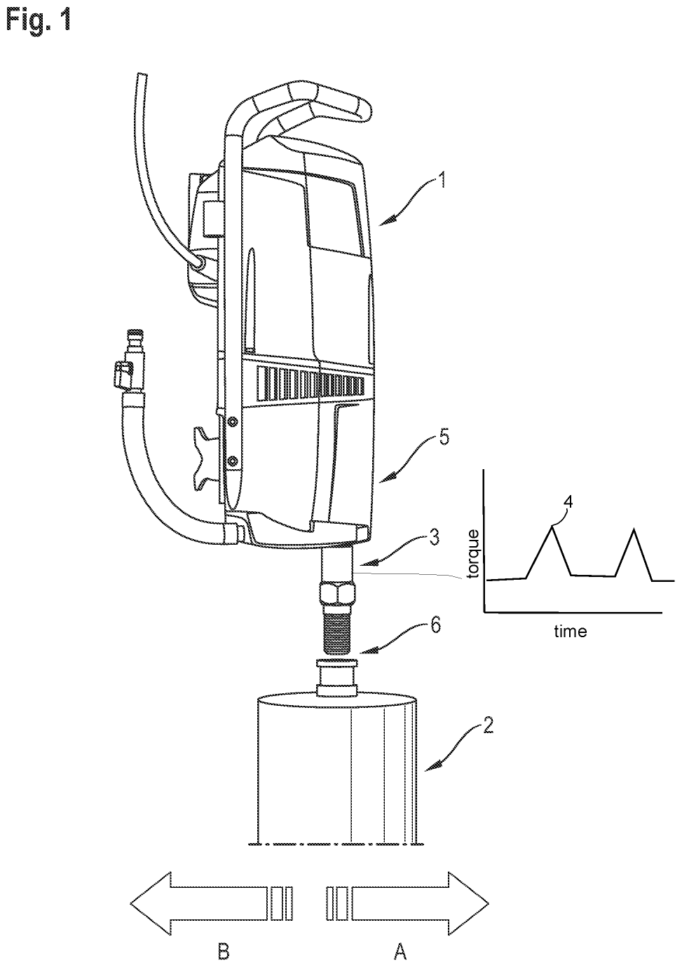

FIG. 1 shows a proposed core drilling device 1 with which the proposed method for separating a drill bit 2 from a core drilling device 1 can be carried out. During operation of the core drilling device 1, i.e. when it is used for cutting drill cores out of a substrate, it is connected to a drill bit 2, wherein the drill bit 2 is driven into the substrate in order to cut out the drill core. To this end, the drill bit 2 is made to rotate by a drive shaft 3 of the core drilling device 1, wherein the drive shaft 3 for its part is driven by a motor 5 of the core drilling device 1. Provision is made for the drive shaft 3 or the drill bit 2 to be operated in a drilling direction A during operation of the core drilling device 1, i.e. during a drilling operation. This preferably means, according to the invention, that the drill bit 2 rotates for example in a clockwise direction or is driven in rotation in the clockwise direction when a drill core is intended to be cut out of a substrate. The connection between the core drilling device 1 and the drill bit 2 is formed in particular by a screw connection 6. Possible examples of a first direction of rotation A and a second direction of rotation B are indicated schematically in FIG. 1 by arrows. In the actual realization of the invention, the directions of rotation A, B can of course also be interchanged.

After work has been carried out and for transporting the core drilling device 1, it may be necessary or desired for the drill bit 2 to be removed from the core drilling device 1. To this end, the present invention provides for the core drilling device 1 to be operated in a second direction of rotation B that is opposite to the drilling direction A. In other words, when the drill bit 2 is intended to be separated from the core drilling device 1, a reversal of the direction of rotation takes place in that the direction of rotation of the core drilling device 1 is changed. This changing of the direction of rotation preferably consists in the direction of rotation of the core drilling device 1 being switched from a first direction of rotation A to a second direction of rotation B. In the exemplary embodiment of the invention that is mentioned in the preceding paragraph, a counterclockwise direction of rotation would correspond to the second direction of rotation B, while a clockwise rotation corresponds to the drilling direction A or first direction of rotation A.

Furthermore, provision is made for torque spikes 4 (shown solely schematically in FIG. 1) to be applied to the drive shaft 3 of the core drilling device 1, said torque spikes 4 helping to release the screw connection 6 between the core drilling device 1 and drill bit 2. For this purpose, in particular the inertia of the drill bit 2 is exploited. In other words, the drive shaft 3 of the core drilling device 1 can be subjected to torque spikes 4, wherein the torque spikes 6 have such a strength that the drill bit 2 can be released from the core drilling device 1 using them.

### LIST OF REFERENCE SIGNS

1 Core drilling device
2 Drill bit
3 Drive shaft
4 Torque spikes
5 Motor of the core drilling device
6 Screw connection
A Drilling direction
B Second direction of rotation

1-11. (canceled)

12. A method for releasing a screw connection between a core drilling device and a drill bit, the method comprising:
a) providing a core drilling device having a drill bit, the drill bit, during operation of the core drilling device, being fastened to the core drilling device via a screw connection, and having a drive shaft, torque spikes capable of being applied to the drive shaft,
wherein, during operation of the core drilling device, the drill bit is driven in a drilling direction via the drive shaft of the core drilling device,
b) operating the core drilling device in a second direction of rotation, wherein the second direction of rotation is opposite to the drilling direction, and
c) releasing the screw connection between a core drilling device and the drill bit through rotation of the drive shaft in the second direction of rotation.

13. The method as recited in claim 12 wherein the screw connection between the core drilling device and the drill bit is released without a tool.

14. The method as recited in claim 12 wherein the torque spikes release the screw connection between the core drilling device and the drill bit when the drive shaft of the core drilling device is driven in the second direction of rotation.

15. A core drilling device configured to carry out the method as recited in claim 12.

16. The core drilling device as recited in claim 15 wherein the torque spikes are designed to release the screw connection between the core drilling device and the drill bit when the drive shaft of the core drilling device is driven in the second direction of rotation.

17. The core drilling device as recited in claim 15 further comprising comprises a motor for driving the drive shaft, wherein the motor is configured to generate the torque spikes, a strength of the torque spikes being sufficient to effect the releasing of the screw connection between the core drilling device and the drill bit.

18. The core drilling device as recited in claim 15 wherein the motor of the core drilling device is a brushless motor.

19. The core drilling device as recited in claim 15 wherein the core drilling device is a diamond core drilling device, and the drill bit is a diamond drill bit.

20. The method as recited in claim 12 wherein reversal of the direction of rotation of a drive shaft of the core drilling device in step b) is combined with application of the torque spikes to the drive shaft to effect the releasing of the screw connection in step c).

21. The method as recited in claim 12 wherein the drive shaft of the core drilling device is subjected to the torque spikes during operation of the core drilling device in the second direction of rotation to effect the releasing of the screw connection.

22. The method as recited in claim 12 further comprising controlling a motor of the core drilling device with instructions executable by a computer program, the computer program executing the method steps as recited in claim 12.
